(19) United States
(12) Patent Application Publication
(10) Pub. No.: US 2016/0375600 A1
(43) Pub. Date: Dec. 29, 2016

(54) JOINT CUTTING IN A DEVICE

(71) Applicants: Igor Markovsky, Redwood City, CA (US); Michael Nikkhoo, Saratoga, CA (US); Scott Francis Fullam, Palo Alto, CA (US)

(72) Inventors: Igor Markovsky, Redwood City, CA (US); Michael Nikkhoo, Saratoga, CA (US); Scott Francis Fullam, Palo Alto, CA (US)

(21) Appl. No.: 14/754,505

(22) Filed: Jun. 29, 2015

(51) Int. Cl. B26D 7/10

(52) U.S. Cl. CPC B26D 7/10

(57) ABSTRACT

Examples are disclosed that relate to heat-based cutting of an adhesive joint of a device. One disclosed example provides a device, comprising an adhesive joint connecting a first component and a second component via an adhesive layer, and a cutting affordance incorporated within the device and positioned within the adhesive joint or adjacent the adhesive joint.

### BACKGROUND

Adhesive layers are commonly used in devices to connect one component to another component at a joint. For example, adhesive joints may be used to attach cosmetic and functional components of a device.

### SUMMARY

Examples are disclosed that relate to heat-based cutting of an adhesive joint of a device. One disclosed example provides a device comprising an adhesive joint connecting a first component and a second component via an adhesive layer, and a cutting affordance incorporated within the device and positioned within the adhesive joint or adjacent the adhesive joint.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example device including an adhesive joint and an example affordance for cutting the joint.

FIG. 2 shows a cross-section view of the example device of FIG. 1 taken along line A-A of FIG. 1.

FIG. 3 shows another example device including an affordance for cutting an adhesive joint.

FIG. 4 shows another example device including an affordance for cutting an adhesive joint.

FIG. 5 shows an example heat-based cutting tool configuration in which an approximately net-zero shear force is applied by the heat-based cutting tool when cutting an adhesive joint of the device.

FIG. 6 shows an example heat-based cutting tool configuration in which a directional shear force is applied by the heat-based cutting tool when cutting an adhesive joint of the device.

FIG. 7 shows another example heat-based cutting tool configuration in which an approximately net-zero shear force is applied by the heat-based cutting tool when cutting an adhesive joint of the device.

FIG. 8 shows an example heat-based cutting device having a plurality of portions configured to heat at different rates.

FIG. 9 shows an example connector for a heat-based cutting tool according to the present disclosure.

FIG. 10 shows another example connector for a heat-based cutting tool according to the present disclosure.

FIG. 11 shows a cross-section of an example heat-based cutting device.

FIG. 12 shows a cross-section of another example heat-based cutting device.

FIG. 13 shows a cross-section of another example heat-based cutting device.

FIG. 14 shows an example tool operable to apply heat and pulling force to a heat-based cutting tool.

FIG. 15 shows an example heat source operable to heat a heat-based cutting tool via electrical inductance.

FIG. 16 shows an example heat source operable to apply ultrasonic pressure waves to the heat-based cutting tool according to an excitation frequency that resonates the heat-based cutting tool.

### DETAILED DESCRIPTION

The repair an electronic device may involve the separation of adhesive joints within the device, for example, to access interior structures of a device or to remove a part for replacement. Some approaches for disassembling an adhesive joint include use of a solvent to dissolve the adhesive, applying heat to soften the adhesive, and mechanically cutting the adhesive. However, each of these approaches risk damaging components of the device. For example, if applied inaccurately, a solvent can dissolve or otherwise degrade components positioned near the adhesive joint. Exposure to heat (e.g., from a heat gun) can damage components positioned near the adhesive joint. Further, an adhesive joint may be difficult to access with a mechanical cutting tool, and such cutting tools can damage other components.

Accordingly, examples are disclosed that relate to affordances incorporated into devices for the heat-based cutting of adhesive joints of the devices. A cutting affordance may take the form of a structure to receive insertion of a heat-based cutting tool, and/or may take the form of a heat-based cutting tool incorporated into the device during manufacturing to facilitate later cutting, as examples. A heat-based cutting tool further may include structures for coupling to a heat source operable to heat the heat-based cutting tool. The heat source may provide energy to heat the heat-based cutting tool to a temperature above a glass transition temperature of an adhesive employed in the adhesive joint, thereby allowing the heat-based cutting tool to soften the adhesive. The heat source and heat-based cutting tool also may include mechanical features to facilitate the application of a pulling force on the heat-based cutting tool. In this manner, localized heating may be applied by the heat-based cutting tool to the adhesive layer of the adhesive joint with little thermal effect on other surrounding components of the device. Moreover, because the adhesive layer is softened by the localized heating, the heat-based cutting tool may be pulled through the adhesive joint with little or no net force being applied to the other surrounding components. These and other examples are described in more detail below.

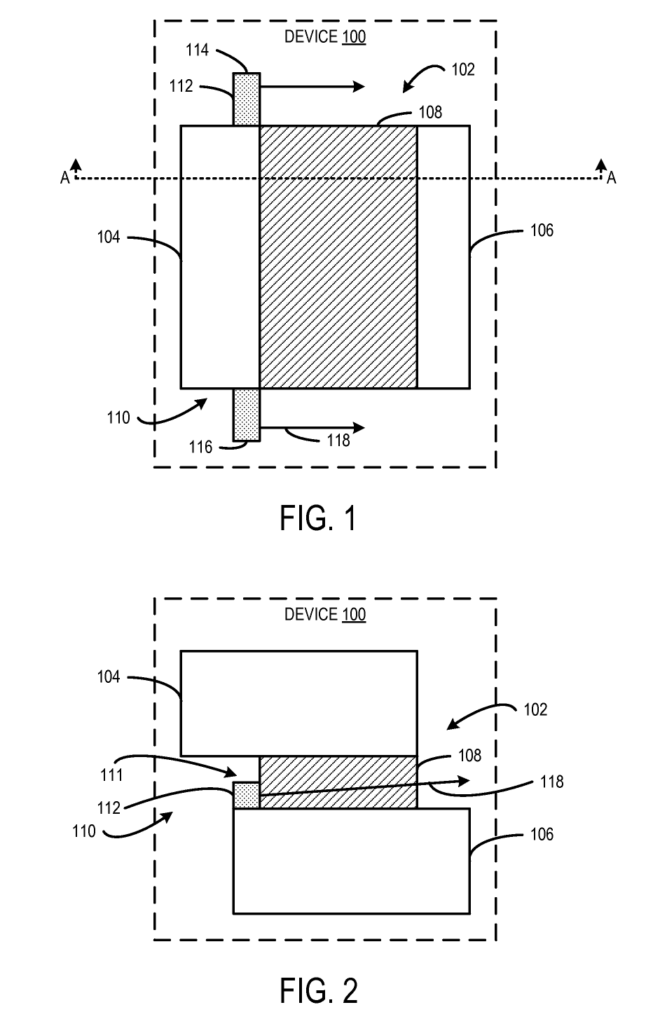

FIGS. 1-2 schematically show an example device 100 in simplified form. The depicted device 100 may represent any suitable type of device, such as a computing device (e.g. tablet computer, mobile phone, laptop computer, etc.). The device 100 includes an adhesive joint 102 connecting a first component 104 and a second component 106 via an adhesive layer 108. Non-limiting examples of such components may include printed circuit boards, sensor systems, flexible circuits, displays, optical elements, heat sinks, trim pieces, and bezel pieces. It will be understood that any suitable type of component may be adhered to another component or structure via an adhesive layer to form an adhesive joint. Moreover, any suitable type of adhesive may be employed to adhere one or more components to another component or structure to form an adhesive joint.

FIGS. 1-2 also illustrates an example cutting affordance 110 incorporated within the device 100. The cutting affordance 110 is configured to facilitate the heat-based cutting of the adhesive joint 102 to separate the first component 104 from the second component 106.

In the depicted example, the cutting affordance 110 includes a heat-based cutting tool 112 positioned within a space 111 between the first component 104 and the second component 106 of sufficient clearance to allow the heat-based cutting tool 112 to move within the space 111. In other implementations, a cutting affordance may include a heat-based cutting tool positioned within the adhesive joint 102, such that the heat-based cutting tool is held in place by the adhesive. In either case, the heat-based cutting tool 112 may be incorporated into the device 100 at the time of manufacture to provide for convenient access for any repair processes.

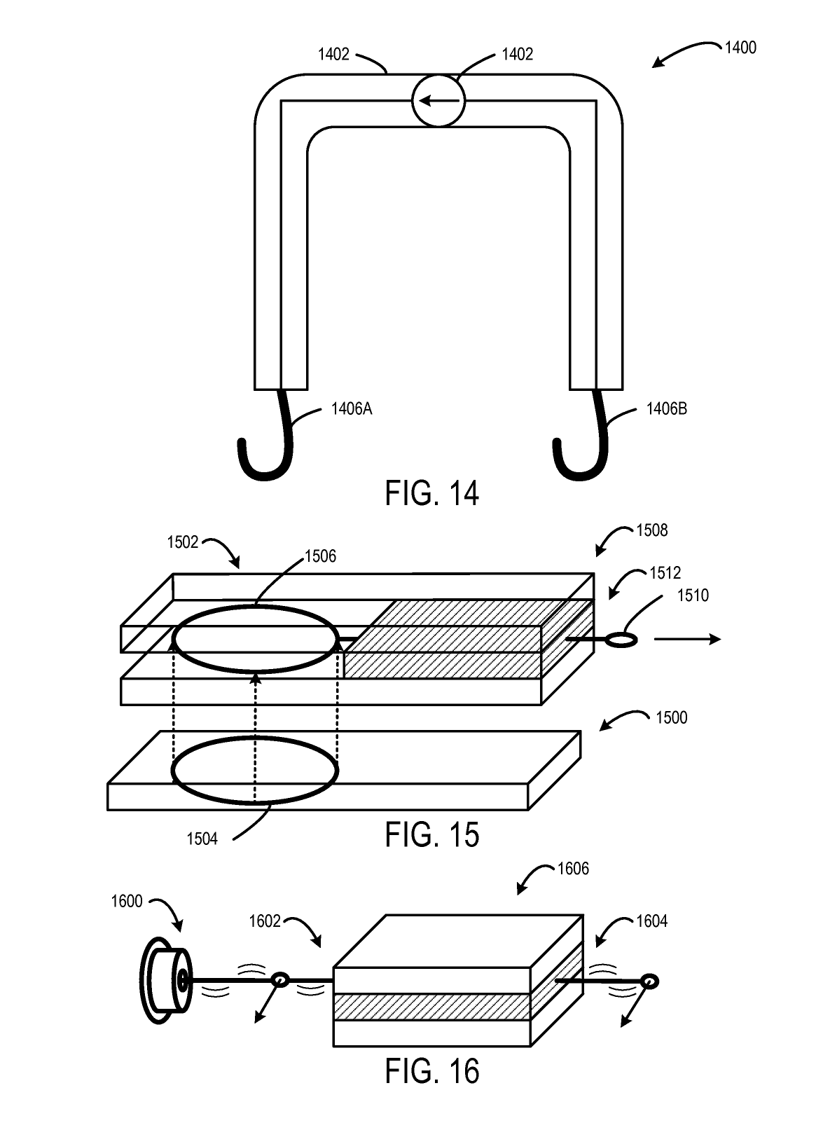

The heat-based cutting tool 112 may have a shape and placement configured to allow the heat-based cutting tool to be drawn through the adhesive joint (when heated) without impediment from other parts. The heat-based cutting tool 112 may be configured to connect to a heat source (examples of which are shown in FIGS. 14-16) operable to heat the heat-based cutting tool 112. Additionally, the heat-based cutting tool 112 may be configured to mechanically connect to a pulling tool that facilitates the application of a pulling force when heated.

The depicted heat-based cutting tool 112 includes a first end 114 and a second end 116. The first end 114 and the second end 116 may be positioned within the device 100 for convenient access during a repair process. For example, as shown in FIG. 1, the first end 114 and the second end 116 may extend beyond the edges of the adhesive joint 102. Further, in some implementations, the heat-based cutting tool 112 may include one or more connectors configured to mechanically connect to the pulling tool. Such connectors may be located at the first end 114 and the second end 116, or at other suitable locations.

When it is desired to cut the adhesive joint 102, the heat-based cutting tool 112 may be connected to the heat source to heat the heat-based cutting tool 112 to a temperature at or above the glass transition temperature (T_{g}) of the adhesive. At such temperatures, the heat-based cutting tool 112 may be pulled through the adhesive layer 108 (from left to right in the illustrated example) to soften and cut the adhesive, and thereby separate the first component 104 from the second component 106.

Once the first component 104 is separated from the second component 106, one or both of the first and second components 104, 106 may be repaired or replaced as desired. Further, after repair, the heat-based cutting tool 112 may be re-positioned in device 100, and the adhesive joint 102 may be reformed by re-applying the adhesive layer 108 between the first component 104 and the second component 106, thereby reforming the cutting affordance 110 for possible future use.

In one specific, non-limiting implementation, a nichrome wire may be used in conjunction with an adhesive joint 102 having a width of 16 mm, a length of 10 mm, and a layer of an adhesive having a thickness of 0.2 mm and a T_{g} of 80° C. In such an example, the adhesive joint 102 may be cut by pulling the heat-based cutting tool 112 with a force of ˜6-8 N when the heat-based cutting tool 112 is heated to or above the T_{g}. It will be understood that numerous other configurations are possible.

The cutting affordance 110 may be configured to allow the heat-based cutting tool 112 to be pulled through the adhesive joint 102 in any suitable direction. The pulling direction 118 may be based on a layout of the adhesive joint 102, a shape/dimensions of the first component 104 and the second component 106, as well as the configuration other components in the device 100 and the device 100 as a whole.

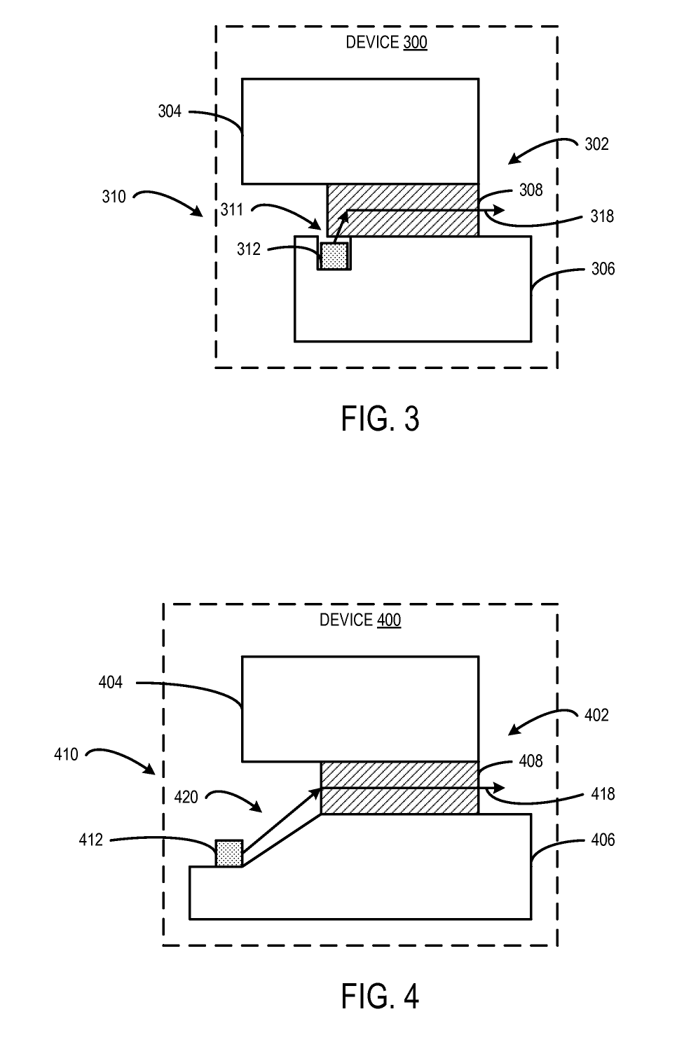

FIGS. 3-4 show other examples of cutting affordances. First referring to FIG. 3, a device 300 includes a cutting affordance 310 comprising a groove 311 positioned within the adhesive joint 302 and defined by the second component 306. The groove 311 is configured to accommodate the heat-based cutting tool 312, such that the heat-based cutting tool 312 may be incorporated into the device 300 at the time of device manufacture. In this manner, the heat-based cutting tool 312 may reside in the device 300 until it is used to cut the adhesive joint 302. In other embodiments, the heat-based cutting tool 312 may be inserted into the groove 311 when the joint is to be cut, rather than at the time of manufacture. In yet other embodiments, groove 311 may be omitted, and the heat-based cutting tool 312 may be incorporated directly into the adhesive joint or into a space adjacent to the adhesive joint at the time of manufacture, as described above with regard to FIGS. 1-2.

Next referring to FIG. 4, the heat-based cutting tool is spaced from the adhesive joint 402 by a mechanical guide in the form of a lead-in or ramp 420. The ramp 420 may be configured to guide the heat-based cutting tool 412 into the adhesive joint 402 when the heat-based cutting tool 412 is pulled. The ramp 420 may have any suitable shape, size, angle, or other dimensional characteristics to allow the heat-based cutting tool 412 to be smoothly pulled into the adhesive joint 402. In this implementation, the heat-based cutting tool 412 need not be incorporated into the device 400 at the time of manufacturing. Rather, the ramp 420 may allow may facilitate the insertion of the heat-based cutting tool 412 into the joint 402 when disassembly of the joint 402 is desired. In the depicted implementation, the ramp 420 and the heat-based cutting tool 412 may together be considered a cutting affordance.

In some implementations, a device may include physical features other than a ramp configured to guide the heat-based cutting tool during disassembly via the heat-based cutting tool, and/or to ensure that other components are not damaged during cutting. Examples include, but are not limited to, thermal insulators, mechanical stops, and cutting tool guides.

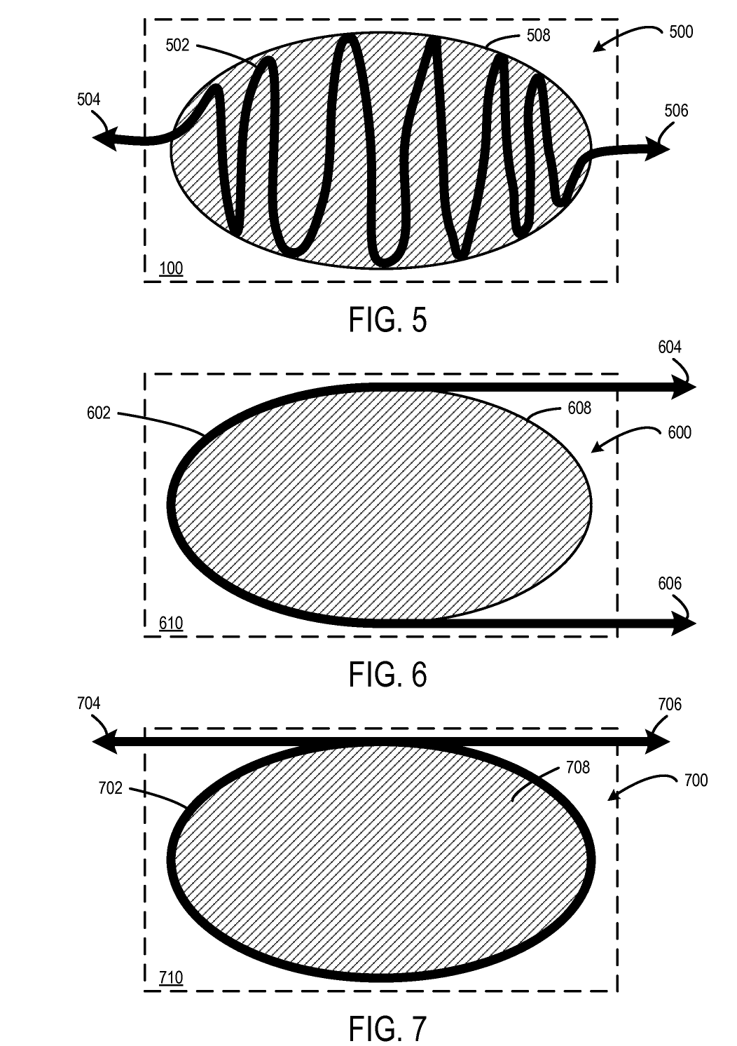

FIGS. 5-7 show example arrangements of the heat-based cutting tool relative to an adhesive joint being cut. In the illustrated examples, the arrows indicate example pulling directions for the heat-based cutting tool to cut the adhesive joint. A shape of the adhesive joint is shown in simplified form and may differ from an actual shape of the adhesive joint in the device.

First, FIG. 5 shows an example layout 500 of a heat-based cutting tool 502 including a first end 504 and a second end 506. In the layout 500, the first end 504 and the second end 506 are pulled in opposing directions to cut an adhesive joint 508 a device 510. The layout 500 may cause an approximately net-zero shear force to be applied by the heat-based cutting tool 502 on the device 510 when the heat-based cutting tool 502 is pulled to cut the adhesive joint 508.

Next, FIG. 6 shows an example layout 600 of a heat-based cutting tool 602 including a first end 604 and a second end 606. In the layout 600, the first end 604 and the second end 606 are pulled in the same direction to cut an adhesive joint 608 of a device 610. Layout 600 may cause a directional shear force to be applied by the heat-based cutting tool 602 on the device 610 in a direction of pulling when the heat-based cutting tool 602 is pulled to cut the adhesive joint 608.

FIG. 7 shows an example layout 700 of a heat-based cutting tool 702 including a first end 704 and a second end 706. In the layout 700, the first end 704 and the second end 706 are pulled in opposing directions to cut an adhesive joint 708 of a device 710. Layout 700 may cause an approximately net-zero shear force to be applied by the heat-based cutting tool 702 on the device 710 when the heat-based cutting tool 702 is pulled to cut the adhesive joint 708. Unlike layouts 500 and 600, different portions of the heat-based cutting tool 702 may overlap each other and possibly touch when the heat-based cutting tool 702 is being pulled. Accordingly, a heat-based cutting tool may include an electrical insulation coating or layer to avoid shorting in such circumstances. The above described layouts of the heat-based cutting tool are described for the purpose of example, and any other suitable layout may be used.

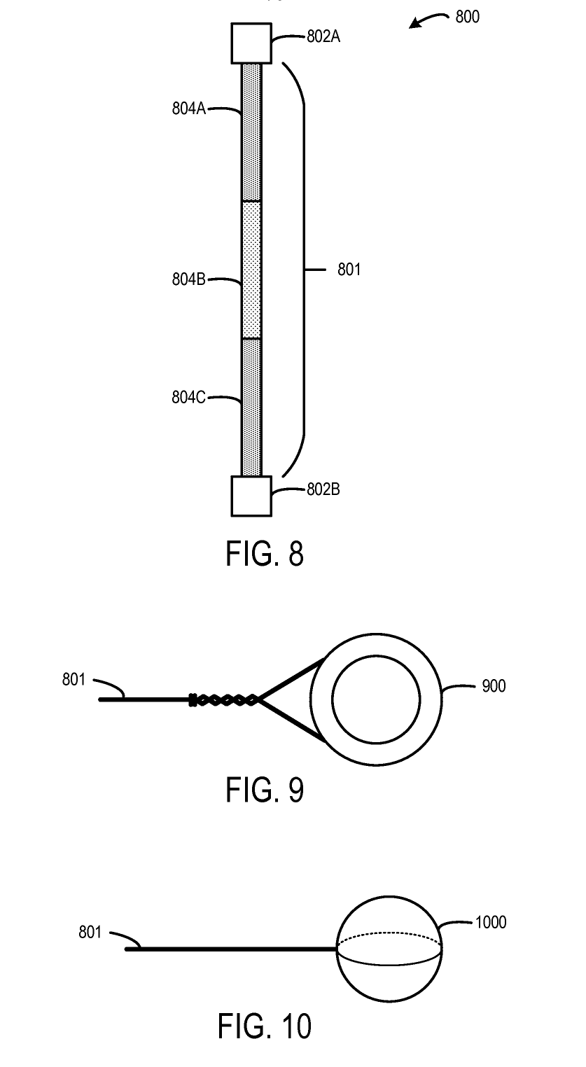

A heat-based cutting tool for cutting an adhesive joint may have any suitable configuration. FIG. 8 schematically shows one example heat-based cutting tool 800. The heat-based cutting tool 800 includes a cutting segment 801 and a plurality of connectors 802 (namely, connector 802A and connector 802B disposed at opposite ends of the cutting segment 801) that are coupled with the cutting segment 801. The cutting segment 801 may be configured to be resistively heated via connection to an electrical current source. In other examples, a cutting segment a may be heated by application of other forms of energy.

In some implementations, the cutting segment 801 may be configured to heat substantially uniformly along its length. In other configurations, the cutting segment 801 may include a plurality of portions (e.g., 804A, 804B, 804C) that heat at different rates. For example, a first portion 804A and a third portion 804B may be configured to heat at a slower rate than a second portion 804B. The cutting segment 801 may include any suitable number of such portions, and the portions may utilize any suitable properties, such as different electrical resistances, to heat at different rates. As one example, the first and third portions 804A, 804C may be formed from steel and the second portion 804B may be formed from a nichrome alloy.

The plurality of connectors 802 may be configured to mechanically connect to a pulling tool operable to pull the cutting segment 801 through an adhesive joint of a device. The plurality of connectors 802 may take any suitable form. For example, FIG. 9 shows an example connector in the form of a grommet 900 including a ring shape around which the cutting segment 801 may be wrapped and a central opening through which hooks or other fasteners of a pulling tool may be connected. In some implementations, the grommet 900 may be electrically conductive such that a pulling tool connected to the grommet 900 can also provide electrical current to heat the cutting tool.

FIG. 10 shows another example connector in the form of a small sphere 1000 that may be connected to a pulling tool. For example, a pulling tool may include a slot configured to accommodate cutting segment 801, wherein a width of the slot is smaller than a diameter of the sphere 1000. The sphere 1000 may be attached to the cutting segment 801 in any suitable manner, including but not limited to welding, casting, crimping, and clamping. In some implementations, the sphere 1000 may be electrically conductive such that a pulling tool connected to the sphere 1000 can also provide electrical current to heat the cutting segment 801. The above described connectors are examples, and numerous other types of connectors may be employed on the heat-based cutting tool 800.

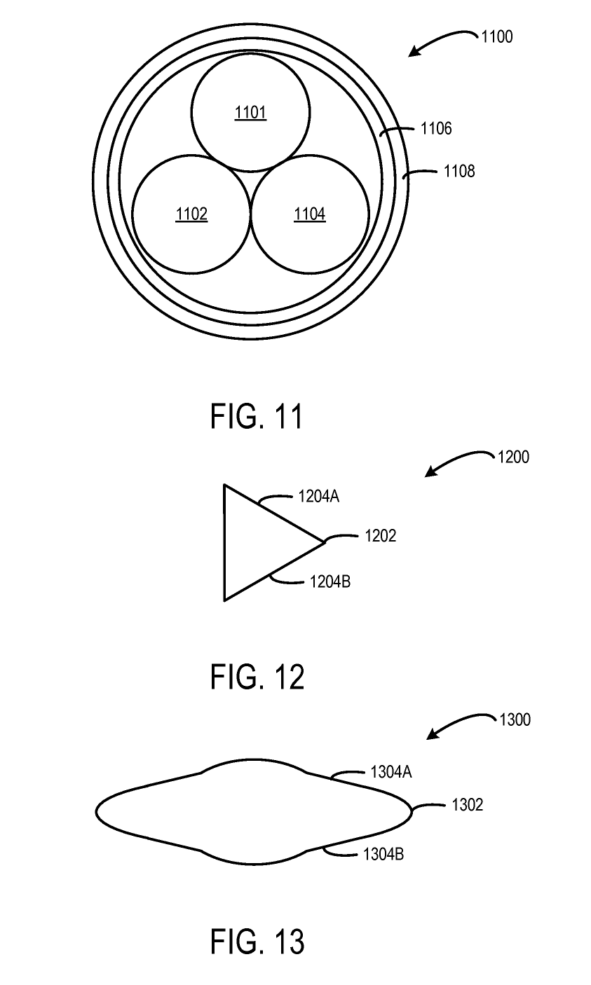

In some implementations, the cutting segment of a heat-based cutting tool may include a plurality of different internal structures that each serve a particular purpose with regard to cutting an adhesive joint. FIG. 11 shows a cross-section of the heat-based cutting tool 1100 including a plurality of core elements and a plurality of coating elements. For example, the core elements may include a load carrier element 1101, a thermal element 1102, and a temperature sensor 1104, and the coating elements may include an electrical insulation coating 1106 and a non-stick coating 1108.

The load carrier element 1101 may help strengthen the heat-based cutting tool 1100 to prevent the heat-based cutting tool 1100 from breaking during pulling. For example, the load carrier element 1101 may include Kevlar or another high-strength material. The thermal element 1102 may have thermal properties that allow the thermal element 1102 to quickly increase in temperature. For example, the thermal element 1102 may include a conductive material, such as a nichrome alloy or another resistive heating material.

The temperature sensor 1104 may be configured to measure a temperature of the cutting segment 801 and provide the measured temperature to a heat source (e.g., an electrical current source), such that the heat source may adjust heating of the cutting segment 801 based on the temperature measured by the temperature sensor 1104. The temperature sensor 1104 may include one or more thermocouples, and/or any other suitable temperature sensors. The heat-based cutting tool 1100 may include any number and/or type of core elements, including but not limited to those listed above. The core elements may be wound, braided, or otherwise coupled together in any suitable manner. Further, in some examples, the cutting segment 801 may be formed from a single material, e.g. an electrically resistive wire.

The electrical insulation coating 1106 may prevent different portions of the cutting segment 801 from electrically contacting each other. For example, in some implementations, the heat-based cutting tool 1100 may be heated by passing an electrical current through the cutting segment 801. As such, the electrical insulation coating may prevent the heat-based cutting tool 1100 from electrically shorting when different portions of the heat-based cutting tool 1100 come in contact with each other (e.g., such as during pulling in the layout 700 shown in FIG. 7), and also may prevent electrical current from flowing to other components of the device 100, such as any metal components within the device, in the event the cutting segment 801 contacts such components. The non-stick coating 1108 may be formed from a material selected to allow the heat-based cutting tool 1100 to cut through an adhesive joint with little or no adhesive sticking to the heat-based cutting tool 1100. The non-stick coating 1108 may include any suitable material that adheres with sufficient strength to underlying layers (e.g. electrical insulation coating 1106 where present) while cutting through an adhesive joint without sticking to the adhesive material.

In some implementations, a single coating may provide both non-stick and electrically insulating properties. It will be understood that the heat-based cutting tool 112 may include any suitable number and/or type of coating elements, including but not limited to those above. Further, in some examples, coatings may be omitted.

In some implementations, the cutting tool 1100 may be configured to administer solvent to a local area of a joint to be cut. The localized application of solvent via the cutting tool 1100 may allow for easy cutting and disassembly of the joint. For example, the cutting tool 1100 may include a hollow tube including one or more nozzles or holes through which solvent may be delivered to the adhesive of the joint. Solvent may be delivered to the joint via the cutting tool 1100 in any suitable manner

In the example of FIG. 11, the cross-section of the heat-based cutting tool 1100 is circular, but in other examples a heat-based cutting tool may have any other suitable cross-sectional shape. For example, FIG. 12 shows a heat-based cutting tool 1200 having a triangular cross-section. The heat-based cutting tool 1200 may include a cutting edge 1202 and separation features 1204 (e.g., faces 1204A, 1204B) that extend from the cutting edge 1202. In this example, when the heat-based cutting tool 1200 is heated, the cutting edge 1202 may provide very focused and localized heating of the adhesive that interacts with the cutting edge 1202. As such, the adhesive may be heated very quickly. Further, as the heat-based cutting tool 1200 is pulled through the adhesive joint, the separation features 1204 in combination with the cutting edge 1202 may act as a wedge that separates the softened adhesive.

FIG. 13 shows a heat-based cutting tool 1300 having an oblong-oval cross-section. The heat-based cutting tool 1300 may include a cutting edge 1302 and separation features 1304 (e.g., portions 1304A, 1304B) that extend from the cutting edge 1302. Such a configuration may cut in a similar manner to the configuration shown in FIG. 12.

A heat-based cutting tool may be configured to connect with any suitable heat source and/or pulling tool to be pulled through an adhesive joint. In some implementations, the heat source and the pulling tool may be separate devices. In other implementations, the heat source and the pulling tool may be a single device.

FIG. 14 shows a combined heat source and pulling tool in the form of a pulling tool 1400 including a handle 1402, a current source 1404 (e.g. a battery or connector for an external source), and a pair of hooks 1406 (e.g., 1406A, 1406B). The current source 1404 may be electrically connected to the pair of hooks 1406, which are configured to connect to a corresponding pair of connectors (e.g., a pair of grommets 900) of a heat-based cutting tool. When the pair of hooks 1406 are connected to the corresponding connectors of the heat-based cutting tool, the current source 1404 may apply a current through the heat-based cutting tool to heat the heat-based cutting tool. In some examples, a temperature sensor of the heat-based cutting tool may provide feedback to the current source 1404, and the current source 1404 may adjust an amount of current supplied to the heat-based cutting tool based on the feedback. It will be noted that hooks 1406 also provide mechanical connections to the heat-based cutting tool that allow the pulling tool 1400 to pull the heat-based cutting tool through the adhesive joint.

In some implementations, the pulling tool 1400 may include mechanical connectors other than hooks 1406, such as clamps or slots. In some examples, pulling tool 1400 may include separate electrical and pulling force connectors. Additionally, in some examples, the handle 1402 may be partitioned into two parts to allow different pull directions for different layouts of heat-based cutting tools.

FIG. 15 shows an example heat source 1500 configured to provide an electrical current to a heat-based cutting tool 1502through electrical induction. The heat source 1500 includes an inductive transmitter coil 1504, and the heat-based cutting tool 1502 may include an inductive receiver coil 1506. The heat source 1500 may be operable to inductively transfer electrical current from the inductive transmitter coil 1504 to the inductive receiver coil 1506 to heat the heat-based cutting tool 1502. In one example, a device 1508 may be set on an induction coupling station including the inductive transmitter coil 1504 to induce an electrical current in the heat-based cutting tool 1502, thereby heating the heat-based cutting tool 1502.

In the illustrated example, a single connector 1510 extends from the inductive receiver coil 1506 to pull the heat-based cutting tool 1502 through an adhesive joint 1512 of the device 1508. In other implementations, a plurality of connectors may be connected to the inductive receiver coil 1506 or another portion of the heat-based cutting tool 1502.

FIG. 16 shows another example heat source in the form of an ultrasonic source 1600. The ultrasonic source 1600 may be operable to pressure apply waves to a heat-based cutting tool 1602 according to an excitation frequency of the ultrasonic source 1600. In one example, the ultrasonic source 1600 may include a piezo buzzer configured to generate pressure waves. Further, the heat-based cutting tool 1602 may include a material configured to resonate at a frequency corresponding to the excitation frequency of the ultrasonic source 1600. As the heat-based cutting tool 1602 resonates, the heat-based cutting tool 1602 may generate friction that heats the heat-based cutting tool 1602. Moreover, as the heat-based cutting tool 1602 resonates, the heat-based cutting tool 1602 may undergo a mechanical vibration or sawing motion that also may help in cutting an adhesive joint 1604 of a device 1606. As such, in some implementations, the ultrasonic source 1600 may be operated throughout the adhesive joint cutting process to resonate the heat-based cutting tool 1602. The ultrasonic source 1600 may be operated at any suitable frequency to resonate the heat-based cutting tool 1602.

In another example, heat may be supplied directly to a heat-based cutting tool. In such implementations, the heat-based cutting tool may include a material with high thermally conductive material to quickly distribute the heat.

In another example implementation, a device, comprises an adhesive joint connecting a first component and a second component via an adhesive layer, and a cutting affordance incorporated within the device and positioned within the adhesive joint or adjacent the adhesive joint. In one example implementation that optionally may be combined with any of the features described herein, the cutting affordance comprise one or more mechanical guides configured to direct the heat-based cutting tool from the cutting affordance through the adhesive joint. In one example implementation that optionally may be combined with any of the features described herein, the cutting affordance comprises a heat-based cutting tool configured to connect to a heat source operable to heat the heat-based cutting tool, and to connect to a pulling tool operable to pull the heat-based cutting tool through the adhesive joint. In one example implementation that optionally may be combined with any of the features described herein, the heat-based cutting tool is configured to apply a net-zero shear force to the device. In one example implementation that optionally may be combined with any of the features described herein, the heat-based cutting tool is configured to apply a directional shear force to the device. In one example implementation that optionally may be combined with any of the features described herein, the heat source comprises an electrical current source. In one example implementation that optionally may be combined with any of the features described herein, the heat source includes an inductive transmitter coil, wherein the heat-based cutting tool includes an inductive receiver coil, and wherein the heat source is operable to inductively transfer electrical current from the inductive transmitter coil to the inductive receiver coil. In one example implementation that optionally may be combined with any of the features described herein, the heat-based cutting tool is configured to be connected to an ultrasonic source. In one example implementation that optionally may be combined with any of the features described herein, the heat-based cutting tool includes a load carrier element and a thermal element. In one example implementation that optionally may be combined with any of the features described herein, the heat-based cutting tool has a cross-section including a cutting edge and one or more separation features extending from the cutting edge.

In another example implementation, a heat-based cutting tool may be configured to separate an adhesive joint of a device. The heat-based cutting tool comprises a cutting segment configured to electrically connect to an electrical current source operable to heat the cutting segment and one or more connectors extending from the cutting segment. The one or more connectors may be configured to mechanically connect to a pulling tool operable to pull the cutting segment through the adhesive joint. In one example implementation that optionally may be combined with any of the features described herein, the cutting segment includes a load carrier element and a thermal element. In one example implementation that optionally may be combined with any of the features described herein, the cutting segment includes a temperature sensor configured to measure a temperature of the cutting segment and provide the temperature to the electrical current source. The electrical current source is configured to adjust heating of the cutting segment based on the temperature measured by the temperature sensor. In one example implementation that optionally may be combined with any of the features described herein, the cutting segment includes a coating. In one example implementation that optionally may be combined with any of the features described herein, the heat-based cutting tool is incorporated in an electronic device. In one example implementation that optionally may be combined with any of the features described herein, the cutting segment has a cross-section including a cutting edge and one or more separation features extending from the cutting edge.

In another example implementation, a device, comprises an adhesive joint connecting a first component and a second component via an adhesive layer, and a heat-based cutting tool incorporated within the device adjacent to or within the adhesive layer. The heat-based cutting tool may be configured to connect to a heat source operable to heat the heat-based cutting tool, and configured to mechanically connect to a pulling tool operable to pull the heat-based cutting tool through the adhesive joint. In one example implementation that optionally may be combined with any of the features described herein, the device includes a guide configured to direct the heat-based cutting tool through the adhesive joint. In one example implementation that optionally may be combined with any of the features described herein, the heat source includes one or more of an electrical current source, an inductive current source, and an ultrasonic source. In one example implementation that optionally may be combined with any of the features described herein, the cutting segment has a cross-section section including a cutting edge and one or more separation features extending from the cutting edge.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A device, comprising:
an adhesive joint connecting a first component and a second component via an adhesive layer; and
a cutting affordance incorporated within the device and positioned within the adhesive joint or adjacent the adhesive joint.

2. The device of claim 1, wherein the cutting affordance comprises one or more mechanical guides configured to direct the heat-based cutting tool from the cutting affordance through the adhesive joint.

3. The device of claim 1, wherein the cutting affordance comprises a heat-based cutting tool configured to connect to a heat source operable to heat the heat-based cutting tool, and to connect to a pulling tool operable to pull the heat-based cutting tool through the adhesive joint.

4. The device of claim 3, wherein the heat-based cutting tool is configured to apply a net-zero shear force to the device.

5. The device of claim 3, wherein the heat-based cutting tool is configured to apply a directional shear force to the device.

6. The device of claim 3, wherein the heat source comprises an electrical current source.

7. The device of claim 3, wherein the heat source includes an inductive transmitter coil, wherein the heat-based cutting tool includes an inductive receiver coil, and wherein the heat source is operable to inductively transfer electrical current from the inductive transmitter coil to the inductive receiver coil.

8. The device of claim 3, wherein the heat-based cutting tool is configured to be connected to an ultrasonic source.

9. The device of claim 3, wherein the heat-based cutting tool includes a load carrier element and a thermal element.

10. The device of claim 3, wherein the heat-based cutting tool has a cross-section including a cutting edge and one or more separation features extending from the cutting edge.

11. A heat-based cutting tool configured to separate an adhesive joint of a device, the heat-based cutting tool comprising:
a cutting segment configured to electrically connect to an electrical current source operable to heat the cutting segment; and
one or more connectors extending from the cutting segment, the one or more connectors being configured to mechanically connect to a pulling tool operable to pull the cutting segment through the adhesive joint.

12. The heat-based cutting tool of claim 11, wherein the cutting segment includes a load carrier element and a thermal element.

13. The heat-based cutting tool of claim 11, wherein the cutting segment includes a temperature sensor configured to measure a temperature of the cutting segment and provide the temperature to the electrical current source, and wherein the electrical current source is configured to adjust heating of the cutting segment based on the temperature measured by the temperature sensor.

14. The heat-based cutting tool of claim 11, wherein the cutting segment includes a coating.

15. The heat-based cutting tool of claim 11, wherein the heat-based cutting tool is incorporated in an electronic device.

16. The heat-based cutting tool of claim 11, wherein the cutting segment has a cross-section including a cutting edge and one or more separation features extending from the cutting edge.

17. A device, comprising:
an adhesive joint connecting a first component and a second component via an adhesive layer; and
a heat-based cutting tool incorporated within the device adjacent to or within the adhesive layer, the heat-based cutting tool being configured to connect to a heat source operable to heat the heat-based cutting tool, and configured to mechanically connect to a pulling tool operable to pull the heat-based cutting tool through the adhesive joint.

18. The device of claim 17, wherein the device includes a guide configured to direct the heat-based cutting tool through the adhesive joint.

19. The device of claim 17, wherein the heat source includes one or more of an electrical current source, an inductive current source, and an ultrasonic source.

20. The device of claim 17, wherein the cutting segment has a cross-section including a cutting edge and one or more separation features extending from the cutting edge.
